(19) United States
(12) Patent Application Publication
(10) Pub. No.: US 2005/0117490 A1
(43) Pub. Date: Jun. 2, 2005

(54) Address data detecting apparatus and address data detecting method

(75) Inventors: Tadashi Kojima, Yokohama-shi (JP); Yutaka Kashihara, Chigasaki-shi (JP); Akihito Ogawa, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/994,530

(22) Filed: Nov. 23, 2004

(30) Foreign Application Priority Data
Nov. 28, 2003 (JP) JP 2003-400900

(51) Int. Cl. G11B 5/09

(52) U.S. Cl. 369/59.23; 369/47.27

(57) ABSTRACT

An address data detecting apparatus comprises a gray code detector which detects gray codes of a land address and a groove address, a converter which converts the gray codes of the land address and groove address into binary codes, a position detector which detects a data uncertain position, and an address detector which detects the address data based on a detection result of the position detector and the gray code of the land address and the gray code of the groove address that are detected by the gray code detector.

### CROSS-REFERENCE TO RELATED APPLICATIONS

This application is based upon and claims the benefit of priority from prior Japanese Patent Application No. 2003-400900, filed Nov. 28, 2003, the entire contents of which are incorporated herein by reference.

### BACKGROUND OF THE INVENTION

1. Field of the Invention

The present invention relates to a processing of a reproduction signal in a recordable optical disk, and particularly, the present invention relates to an address data detecting apparatus and an address data detecting method which improves a reliability of address data detection.

2. Description of the Related Art

In the optical disk, the data is recorded in a spiral track. Therefore, in order for an optical head to correctly follow the spiral track upon recording, a groove has been recorded in advance in a recordable optical disk. In addition, by wobbling the groove at a prescribed period and measuring this wobble period upon reproducing, a scanning rate is detected and a clock signal in synchronization with a rotation rate can be acquired.

Among the recordable media, in a CD-R/RW, a DVD-R/RW, and a DVD+R/RW, a groove recording system for recording data only in a groove track is adopted. However, for a high-density record, a land and groove recording system for recording data both in a land track and a groove track has been developed and it is adopted in a DVD-RAM.

In addition, address data is needed to be recorded in advance in a recordable optical disk. An optical disk apparatus reproduces the address data before recording the data, specifies a position on the optical disk from the reproduced address data, and records the data therein. As a system of recording address data, there are a prepit system for forming a pit in a track in advance, and a wobble modulation system for modulating a groove in accordance with an address. The prepit system is adopted in a DVD-R/RW and a DVD-RAM, and the wobble modulation system is adopted in a CD-R/RW and a DVD+R/RW. In the prepit system, an edge portion of a recorded signal has information, so that the prepit system may lack reliability and it is preferable that address data is recorded in the wobble modulation system. Therefore, a system not wobbling a groove at a single period but recording address data as a wobble by performing phase modulation and frequency modulation with respect to the wobble (namely, a wobble modulation system) has been considered.

In recent years, an optical disk such that data is recorded in the land and groove recording system and track address data is recorded in the wobble modulation system has been proposed (refer to, for example, Japanese Patent Application KOKAI Publication No. 2001-266352 (paragraph 0003)).

This optical disk apparatus described in this publication relates to a track address detecting method for an optical disk of a land and groove system in which address data has been wobble-modulation recorded, and by detecting a gray code and then, converting the gray code into a binary code, and by detecting the address data also from a track width variation position and a detection result of the groove track address upon reproducing a land track, a reliability of the address data is improved.

However, in the land and groove recording system, wobbling is generated in an RF signal since a land address and a groove address must be arranged. In order to make this wobbling area small, a system is proposed, in which track address data is converted in a gray code and then, it is wobble-modulated. According to this system, since a check code of the address data or the like cannot be converted into the gray code, this involves a problem such that it is difficult to add the address check code, and the address data of the detected gray code area has a low reliability.

### BRIEF SUMMARY OF THE INVENTION

An object of the present invention is to provide an address data detecting apparatus and groove recording system capable of detecting address data with a high reliability from a recording medium of a land and groove recording system in which the address data is recorded by using a wobble modulation system.

According to an embodiment of the present invention, an address data detecting apparatus for detecting address data from a recording medium of a land and groove recording system in which a gray code of a land address and a gray code of a groove address are wobble-modulated and recorded, the apparatus comprises:
a gray code detector which detects the gray code of the land address and the gray code of the groove address;
a converter which converts the gray code of the land address and the gray code of the groove address that are detected by the gray code detector into binary codes;
a position detector which detects a bit position of the first “0” or “1” of the binary code viewed from a least significant bit as a data uncertain position; and
an address detector which detects the address data based on a detection result of the position detector and the gray code of the land address and the gray code of the groove address that are detected by the gray code detector.

According to another embodiment of the present invention, an address data detecting apparatus for detecting address data from a recording medium of a land and groove recording system in which a gray code of a land address and a gray code of a groove address are wobble-modulated and recorded, the apparatus comprises:
a gray code detector which detects the gray code of the land address and the gray code of the groove address;
a position detector which detects a data uncertain position with a lower level from among the gray codes of the groove address during recording and reproducing of the land track, and detects a data uncertain position with a lower level from among the gray codes of the land address during recording and reproducing of the groove track; and
an address detector which detects the address data based on a detection result of the position detector and the gray code of the land address and the gray code of the groove address.

According to another embodiment of the present invention, an address data detecting method for detecting address data from a recording medium of a land and groove recording system in which a gray code of a land address and a gray code of a groove address are wobble-modulated and recorded, the method comprises:
a gray code detecting step for detecting the gray code of the land address and the gray code of the groove address;
a converting step for converting the gray code of the land address and the gray code of the groove address that are detected by the gray code detecting step into binary codes;
a position detecting step for detecting a bit position of the first “0” or “1” of the binary code viewed from a least significant bit as a data uncertain position; and
an address detecting step for detecting the address data based on a detection result of the position detecting step and the gray code of the land address and the gray code of the groove address that are detected by the gray code detecting step.

According to another embodiment of the present invention, an address data detecting method for detecting address data from a recording medium of a land and groove recording system in which a gray code of a land address and a gray code of a groove address are wobble-modulated and recorded, the method comprises:
a gray code detecting step for detecting the gray code of the land address and the gray code of the groove address;
a position detecting step for detecting a data uncertain position with a lower level from among the gray codes of the groove address during recording and reproducing of the land track, and detecting a data uncertain position with a lower level from among the gray codes of the land address during recording and reproducing of the groove track; and
an address detecting step for detecting the address data based on a detection result of the position detecting step and the gray code of the land address and the gray code of the groove address.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 shows a relation between a code bit and a wobble phase of address data upon recording the address data by a wobble modulation system;

FIG. 2 shows change of a track width when the wobble phase is different at an inner peripheral side wall and at an outer peripheral side wall of a land track;

FIGS. 3A and 3B show manners of a wobble signal and a data reproduction signal when the phases of the both walls of the track are the same and when the phases of the both walls of the track are different;

FIG. 4 shows a format (a relation among a zone, a track, and a physical segment) of an optical disk;

FIG. 5 shows a layout of address data (WAP) to be given to a physical segment;

FIG. 6 shows a layout of an address field in the address data (WAP);

FIG. 7 shows a layout of a wobble data unit (WDU) of a synchronization field in the address data (WAP);

FIG. 8 shows a layout of a wobble data unit (WDU) of the address field in the address data (WAP);

FIG. 9 shows a layout of a wobble data unit (WDU) of a unity field in the address data (WAP);

FIG. 10 shows a bit modulation rule of the address data;

FIG. 11 shows a layout of a record cluster;

FIG. 12 shows a layout of a data segment;

FIG. 13 shows an example of a wobble modulation;

FIG. 14 shows a time correlative relation of a track width modulation position;

FIG. 15 shows conversion from a binary code into a gray code;

FIG. 16 shows a characteristic of a gray code;

FIG. 17A shows a binary code/gray code converting circuit;

FIG. 17B shows a gray code/binary code converting circuit;

FIG. 18 shows a relation between a wobble signal uncertain position and an address number (a binary code) when gray-coded address numbers are filled with wobble signals;

FIG. 19 shows a detector for an RF signal, a wobble signal, and a tracking error signal;

FIG. 20 is a block diagram of a reproduction signal processing unit;

FIG. 21 is a detailed block diagram of an RF compensation control signal generating unit in the reproduction signal processing unit;

FIG. 22 is a flow chart showing an example of processing of checking track address data;

FIG. 23 is a flow chart showing another example of the processing of checking track address data;

FIG. 24 is a flow chart showing still another example of the processing of checking track address data; and

FIG. 25 is a flow chart showing still further example of the processing of checking track address data.

### DETAILED DESCRIPTION OF THE INVENTION

An embodiment of an address data detecting apparatus and an address data detecting method according to the present invention will now be described with reference to the accompanying drawings.

First, a summary of an optical disk of a land and groove recording system will be described. In the land and groove recording system, data is recorded in both of a land track and a groove track. Therefore, the adjacent land track and groove track share a wall surface. An n-th land track counting from the innermost peripheral side of the optical disk is referred to as a land track “n”. In the same way, an n-th groove track counting from the innermost peripheral side of the optical disk is referred to as a groove track “n”. Further, the groove track “n” is located at the inner peripheral side of the land track “n”.

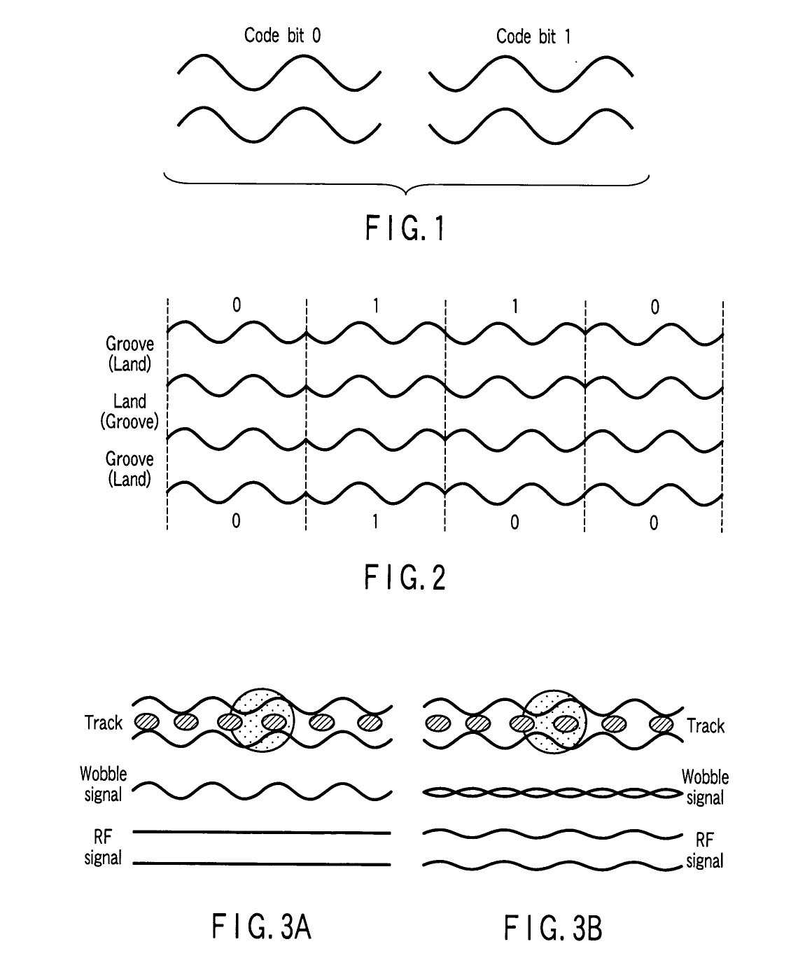

The inner peripheral side of the land track “n” shares the wall surface with the groove track “n” and the outer peripheral side of the land track “n” shares the wall surface with the groove track “n+1”. It is assumed that address data is recorded in a wobble modulation system and a relation between a code bit and a wobble phase of the address data is as shown in FIG. 1. In this case, in the land track “n”, there occurs a part where the wobble phase is different between in the wall surface at the inner peripheral side and in the wall surface at the outer peripheral side as shown in FIG. 2. Moreover, in this part, a track width of the land track “n” is changed.

In the same way, also in the groove track “n”, its inner peripheral side shares the wall surface with the groove track “n−1”, and its outer peripheral side shares the wall surface with the groove track “n”. As shown in FIG. 2, also in the groove track “n”, there occurs a part where the wobble phase is different between in the wall surface at the inner peripheral side and in the wall surface at the outer peripheral side. Further, in this part, a track width of the land track “n” is changed.

The manners of a wobble signal and a data reproduction signal (an address signal as an RF signal) when the phases of both the wall surfaces of the track are the same (FIG. 3A) and the phases of both the wall surfaces of the track are different (FIG. 3B) are shown. As shown in FIG. 3A, when both the wall surfaces of the track are wobbled at the same phase, the wobble signal is detected as a signal that varies as same as the variation of wobbling of the wall surface, and the RF signal recorded on a track is detected as a signal of which lower frequency component is substantially constant.

On the other hand, as shown in FIG. 3B, in a phase area where both the wall surfaces of the track are different, the track width is changed and an all reflection area of a reading beam is changed, so that a direct current offset is occurred in the wobble signal and the RF signal takes a waveform wobbling in response to the wobble signal. In addition, since the wobble signals of both the wall surfaces are inversed phases, a signal is not detected as the wobble signal (a signal is zero). However, actually, a signal of a small level is detected due to deviance of a balance of a differential detector caused by inclination of a detector, a signal amplifier, and an optical beam or the like.

However, the wobble signal phase that is detected in this time cannot be used as the address data. Hereinafter, a position where both the wall surfaces of the track are different is referred to as a track width variation position, an address uncertain position, or an RF signal wobbling position.

According to an embodiment of the present invention, a detection function of the address signal uncertain position is added to a track address detecting unit in a reproducing device, a signal to predict the RF signal wobbling position is detected, and a circuit for compensating for the wobbling of the RF signal is provided at a data reproducing unit in the reproducing device, whereby data can be read correctly.

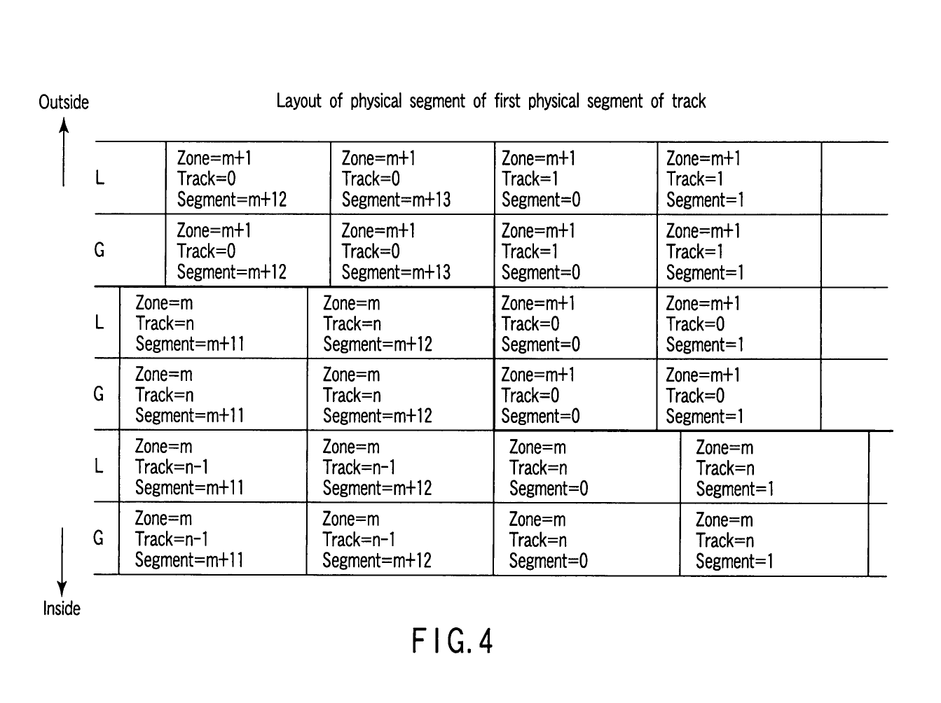

A format of the optical disk according to the present embodiment will be described. A track is divided into the integral number of physical segments, and a zone is configured by a plurality of tracks. FIG. 4 shows a relation among a zone, a track, and a physical segment. A length of the physical segment is 77,469 bytes. One byte is a 12 channel bit. The address data comprises a zone number, a track address, and a segment number for each physical segment. The address data is recorded by modulating a phase of wobbling.

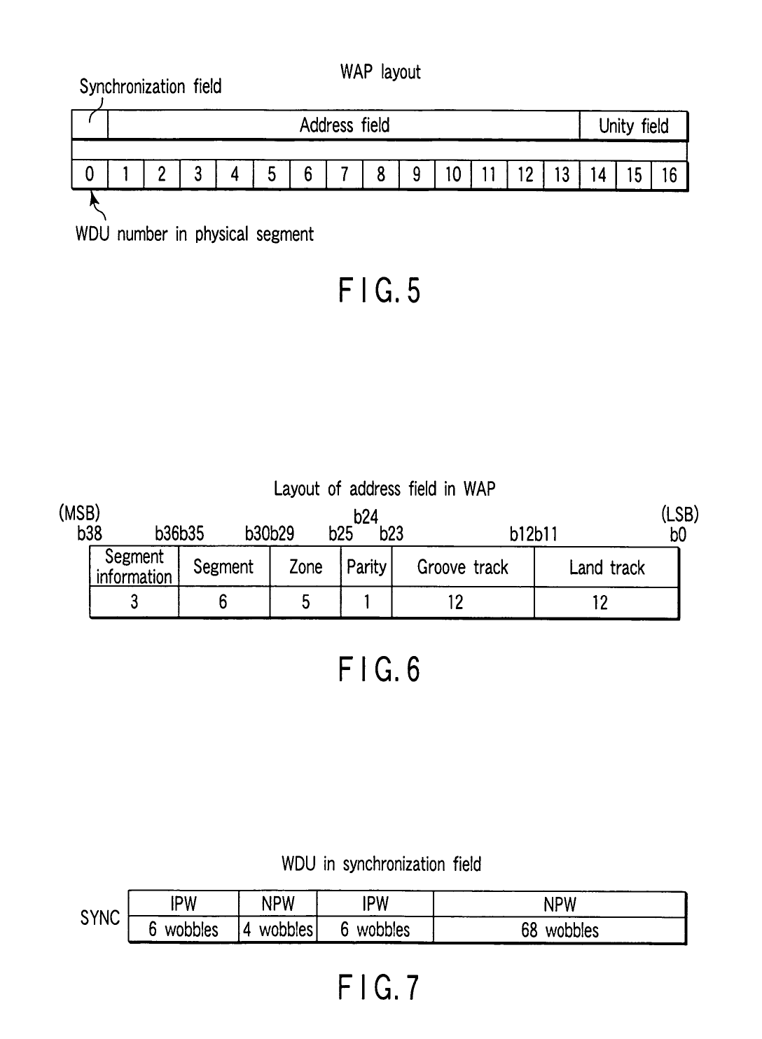

FIG. 5 shows a layout of address data (WAP) to be given to the physical segment. The address data includes a synchronization field, an address field, and a unity field, and is divided into 17 wobble data units (WDU).

The address field is configured as shown in FIG. 6. As described above, according to the land and groove recording system, the adjacent land track and groove the track share the wall surface. Therefore, an address area for groove track and an address area for land track are physically separated. In addition, an address for groove track and an address for land track are recorded by a gray code, respectively. The details of the gray code will be described later.

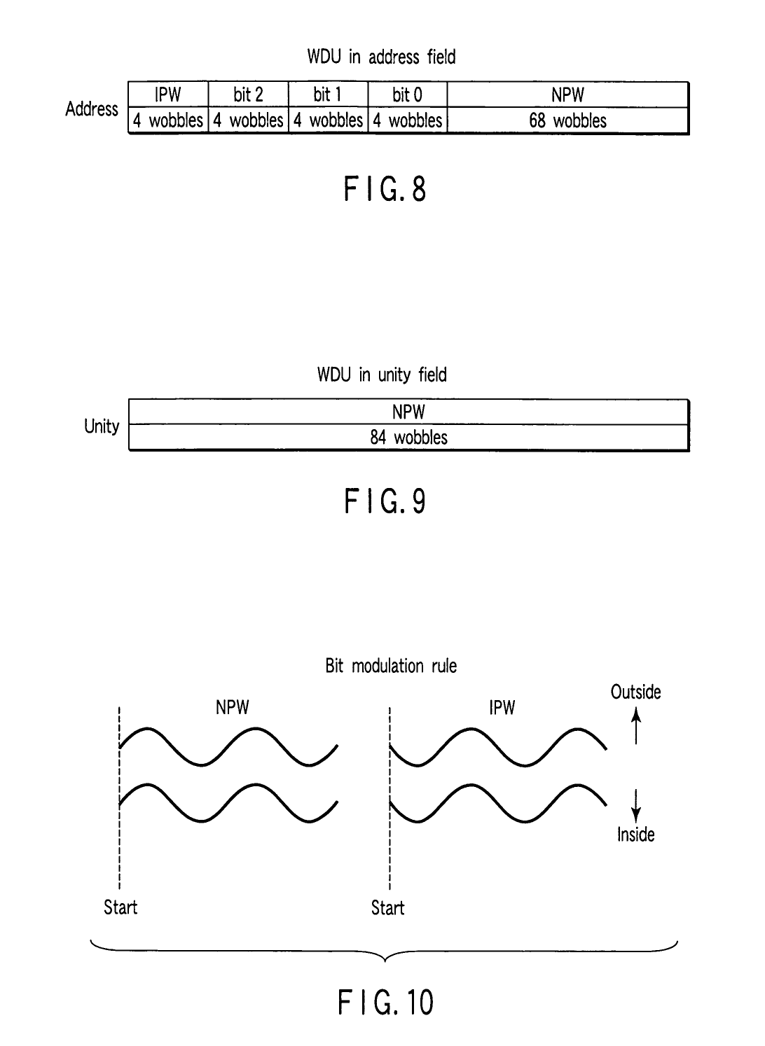

The wobble data unit (WDU) is configured by 84 wobbles. The length of one wobble is 93 bytes. FIGS. 7 to 9 show a layout of the WDU of the synchronization field, a layout of the WDU of the address field, and a layout of the WDU of the unity field, respectively. In the WDU of the address field, address data of 3 bits is recorded, as shown in FIG. 8. In this time, a normal phase wobble (NPW) is recorded with respect to a code bit “0” of the address data, and an inversed phase wobble (IPW) is recorded with respect to a code bit “1” of the address data (FIG. 10).

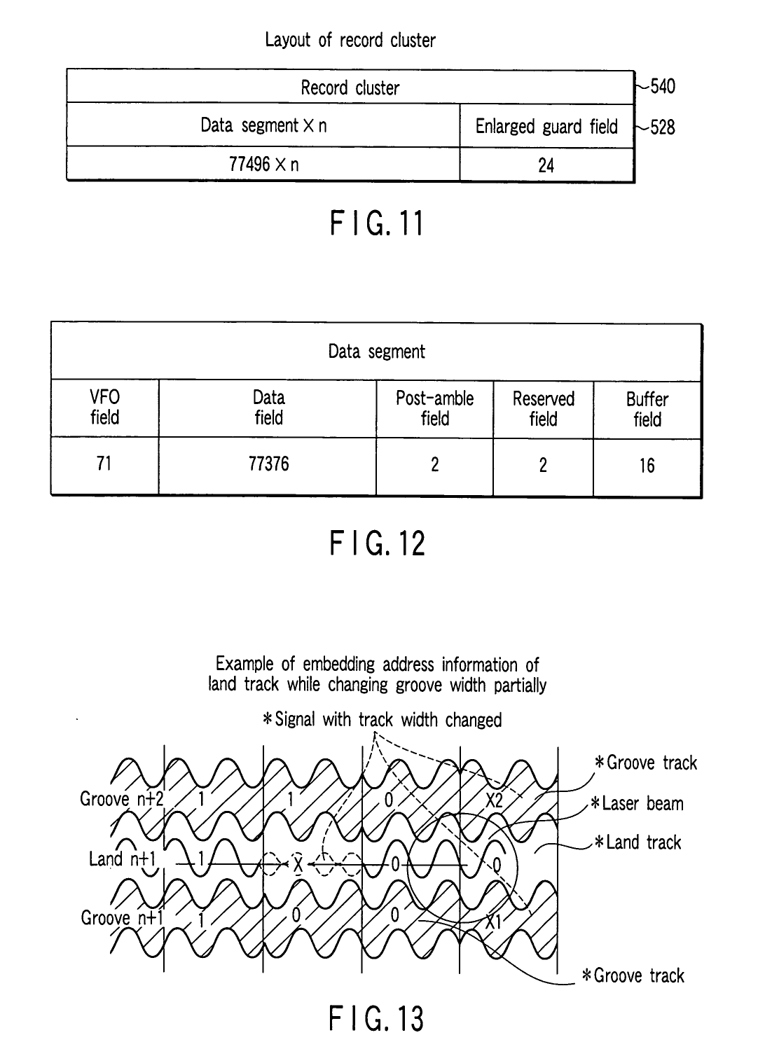

The data is recorded in units of record cluster shown in FIG. 11. The record cluster is configured by “n” data segments and an enlarged guard area. The length of the data segment is the same as that of the physical segment, namely, 77,469 bytes, and its layout is as shown in FIG. 12. In FIG. 12, a length of each field is indicated in units of byte. The data of 7 data segments configures an ECC block.

An (n+1)-th land track counting from the innermost peripheral side of the optical disk is referred to as a land “n+1”. In the same way, an (n+1)-th groove track counting from the innermost peripheral side of the optical disk is referred to as a groove “n+1”. The groove “n+1” is located at the inner peripheral side of the land “n+1”. In this time, a groove track address area of the land “n+1” is noted. As shown in FIG. 13, the inner peripheral side shares the wall surface with the groove “n+1”, and the outer peripheral side shares the wall surface with the groove “n+2”.

Since the track address is recorded by the gray code, in the groove track address area of the physical segment of the land track, the track width is varied for one address bit. In the same way, in the land track address area of the physical segment of the groove track, the track width is varied by one address bit.

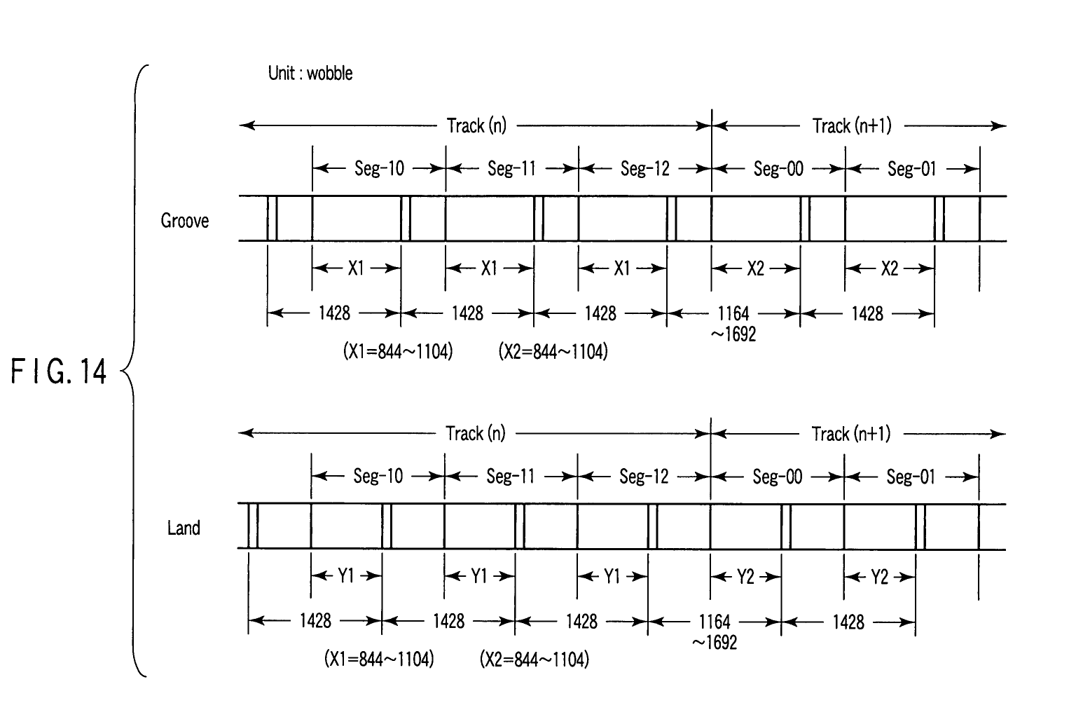

FIG. 14 shows a time correlative relation of a track width variation position. A track width variation position of one address bit is located per physical segment. Since an ECC block as a recording/reproducing block of the data is formed by 7 data segments, by using a segment fly wheel counter after detecting a track width variation position, an error detection eliminating system is used. When the ECC block cross-borders at a connected portion of tracks, the track addresses are different, so that the track width variation position is changed and a time correlation when the track width variation is occurred is different. However, it is also possible to calculate the amount of deviation of a distance at a position where the track address is changed in advance by the track address data.

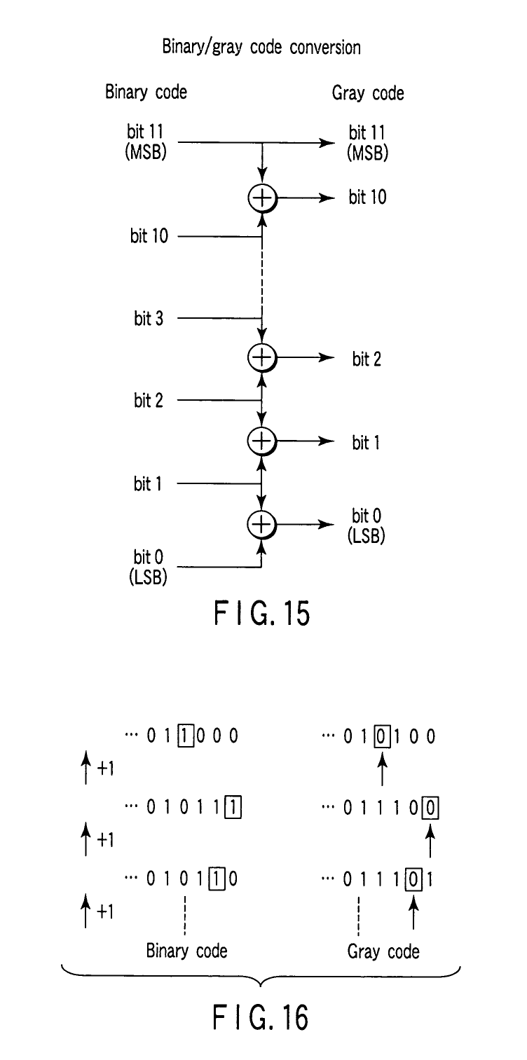

As described above, the track address data is recorded by a gray code. Here, a gray code will be described below. FIG. 15 shows conversion from a binary code into a gray code. A gray code is generated by a value obtained by EX-OR calculating adjacent bits of a binary code in the order from the LSB side, and as an MSB of the gray code, an MSB of the binary code is used as it is.

As shown in FIG. 16, if the binary code is increased +1, only one bit of the gray code is changed and other bits take the same value. In this case, in the binary code, a position of a first “1” viewed from the LSB side becomes a different bit position viewed from the previous gray code.

Such a relation can be described as follows. In other words, when a certain bit is changed from “0” to “1” in an ascending order increase of an alternation binary, the higher bits from the present bit should not be changed, and the lower bits from a position of a changed bit should be changed from “1” to “0”.

Since the gray code takes an EX-OR value of the adjacent codes of the binary code, when the adjacent bits of the binary code are changed together with each other, its EX-OR value is not changed. As a result, a relation between the changed bit position of the gray code and a bit “1” of the converted gray code has the following characteristic.

(1) The bit position of the first “1” viewed from the LSB side of the binary code is defined as a changed bit position of the gray code.

(2) When the value of the binary code is an odd number, the number of the bit “1”s of the gray code is an odd number, and when the value of the binary code is an even number, the number of the bit “1”s of the gray code is an even number.

(3) In the layout of the ascending order of the gray code, the number of the bit “1”s in the code is a repetition from the odd number to the even number (because the changed bit is generated so as to be only one bit between the adjacent codes of the gray code).

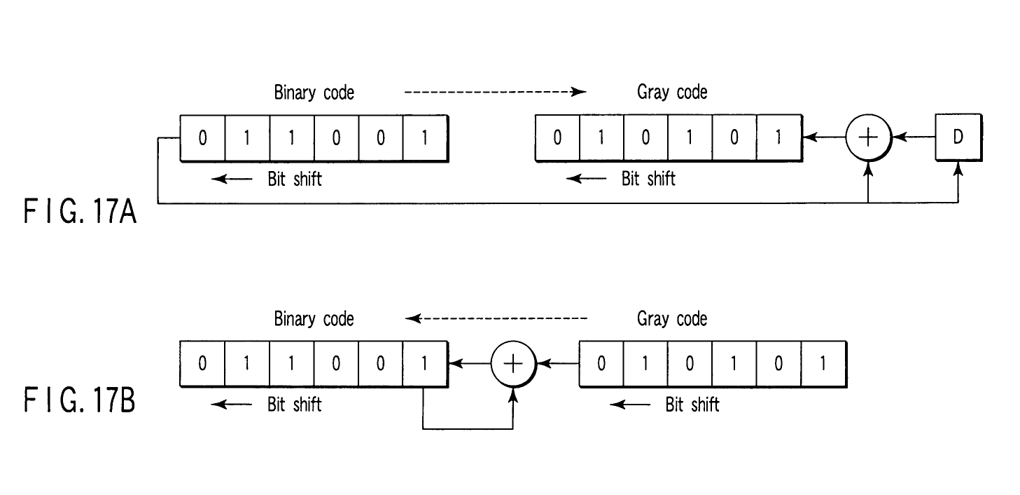

FIG. 17A shows an example of a circuit for converting a binary code (track address data) into a gray code and FIG. 17B shows an example of a circuit for converting a gray code into a binary code. According to these layouts, when address data of one bit progression is converted into a gray code, it is possible to easily detect the changed position of one bit.

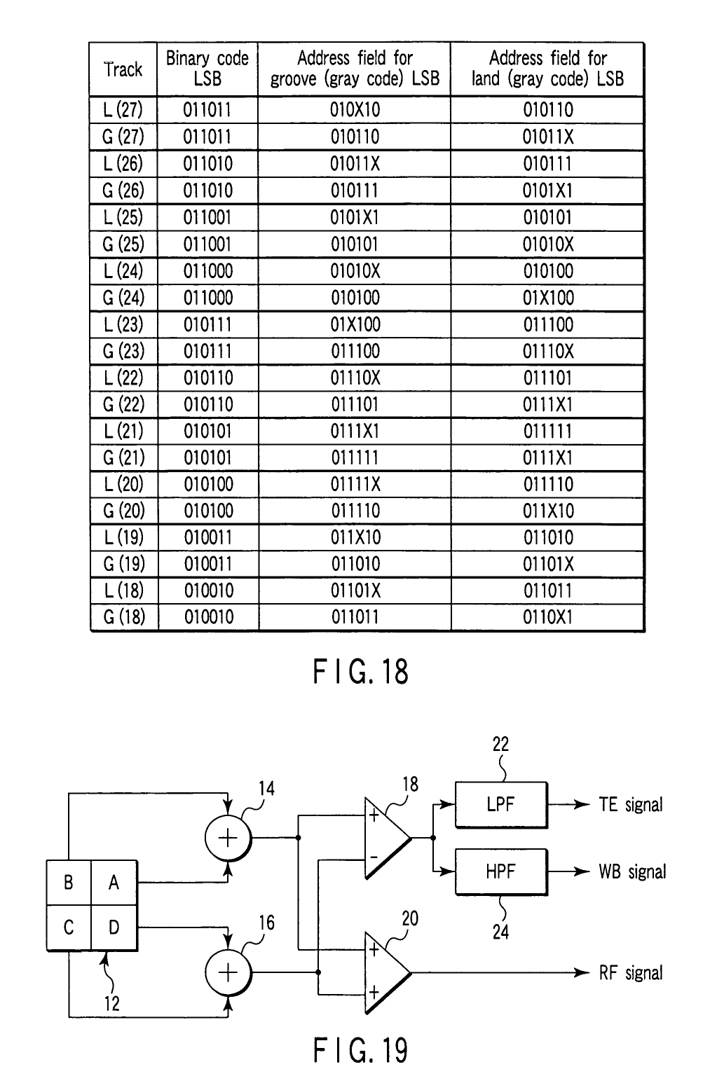

In the case that the gray code is adopted for the track address data in the land and groove recording system, in the track address in the land and groove track, a track address of the ascending order is provided to a groove track and a land track respectively from the innermost periphery toward the outermost periphery, and the zone number and the segment number are collected to be recorded as the address data information. For the actual number of the address bits, 12 bits are used, but a relation when representing only the track address by 6 bits of the gray code is shown in FIG. 18.

FIG. 18 shows a relation between a wobble signal uncertain position and an address number (a binary code) when gray-coded address numbers are filled with wobble signals. A reference symbol “x” in the gray code illustrates an uncertain area of the wobble signal. In the “x” area, a signal is “0” theoretically. However, in the actual reproducing operation, a slight signal level is detected due to track deviation of the reading beam, offset of the detector, or the like. A detection polarity in this case is changed by the condition such as the offset or the like and the “x” area becomes an uncertain area in the advance determination. In this uncertain area, the detected signal has no reliability, so that this uncertain area is not adopted for determination of the data. However, the gray code has a nature that it is changed only by one bit between the adjacent codes, and this portion becomes the uncertain area, so that other area can be used for checking. Therefore, if the position of this uncertain area can be correctly detected, in the land track, by using the groove address data eliminating the land address data and the uncertain portion, it is possible to improve the reliability of detection. FIG. 18 shows an example of track addresses 18 to 27 when it is assumed that the track address is 6 bits. From the binary code, the wobble signal uncertain position of the gray code is obtained in the following relation.

For the land track, the bit position of the first code bit “0” viewed from the LSB side of the binary code corresponds to the wobble signal uncertain position.

For the groove track, the bit position of the first code bit “1” viewed from the LSB side of the binary code corresponds to the wobble signal uncertain position.

Due to such a relation, if the address data of the gray code is detected and the detected gray code is converted into a binary code, it is possible to easily predict a track width variation position. In this case, not only the track width variation position can be predicted, but also the address data can be detected from the track width variation position and the detection result of the groove track (or the land track) address when reproducing the land track (or the groove track), and it may be considered that the address data is written doubly.

From this relation, applying three natures of the gray code and representing the relation, the following matter can be proved.

(1) In the address data of the gray code described in the groove address field of the groove track, the bit position where the first bit “1” viewed from the LSB side at the binary code is allocated becomes a different bit content with respect to the bit arrangement of the gray code address data in the previous track.

In a gray code “010111” of a track G(26), a second bit is changed from “0” into “1” with respect to “010101” of a track G(25). In this case, a binary code of the track G(26) is “011010”.

(2) In the address data of the gray code described in the land address field of the groove track, the bit position where the first bit “1” viewed from the LSB side at the binary code is allocated becomes a different bit content with respect to the bit arrangement of the gray code address data in the previous track.

In a gray code “010101” of a track L(25), a first bit is changed from “0” into “1” with respect to “010100” of a track L(24). In this case, a binary code of the track L(25) is “011001”.

(3) Gray code data to be arranged in a land address field of a groove track address N becomes a content that is synthesized by a gray code of a land address field of a land track address N and a gray code of a land address field of a land track address N-1. In other words, the present gray code takes a value sandwiched between the land track address of the same track address as the groove track address and the gray code of the one previous track. Accordingly, the groove track address of the gray code is converted into a binary code, and the bit position of the first bit “1” viewed from the LSB side of the binary code becomes an uncertain bit position of the gray code that is detected in the land address field.

The gray code to be detected in the land address field of the track G(26) takes a value sandwiched between the gray code “010111” of a track L(26) and the gray code “010101” of the track L(25). If converting the gray code “010111” of the groove address field of the track G(26) into a binary code, it becomes “011010”. In this case, since the second bit is “1”, in the gray code “0101x1” to be detected in the land address field of the track G(26), the second bit is an uncertain “x” and other bits are the same as the value of the groove address field.

(4) Gray code data to be arranged in the groove address field of the land track address N becomes a content that is synthesized by a gray code of a groove address field of a groove track address N+1 and a gray code of the groove address field of the groove track address N. In other words, the present gray code takes a value sandwiched between the groove track address obtained by adding 1 to the land track address and the gray code of the same number as the land track address. Thus, the land track address of the gray code is converted into a binary code, and the bit position of the first bit “0” viewed from the LSB side of the binary code becomes an uncertain bit position of the gray code that is detected in the groove address field. A position of the first bit “1” in the binary code of the groove track address N+1 should be a position of the first bit “0” viewed from the LSB side in the binary code of the track address N. As a result, the position of the first bit “0” of the binary code of the land track address N becomes the uncertain bit position of the gray code detected value of the groove address field.

The gray code to be detected in the groove address field of the track L(25) takes a value sandwiched between the gray code “010111” of the track G(26) and the gray code “010101” of the track G(25). When converting the gray code “010101” of the land address field of the track L(25) into a binary code, it becomes “011001”. In this case, since the second bit is “0, in the gray code “0101x1” to be detected in the groove address field of the track L(25), the second bit is an uncertain “x” and other bits are the same as the value of the land address field.

According to the above-described (1) to (4), it is known that the positions of the first code bits “0” and “1” correspond to the wobble signal uncertain position as viewed from the LSB side of the binary code, so that it is possible to confirm presence/absence of the reliability of the detected address data.

(5) In the gray code data to be detected in the land address field of the groove track address N, the LSB of the gray code sandwiched between the land track addresses N−1 and N becomes the uncertain bit, since the number of “1”s in the code is the odd number when the gray code is the odd number, it becomes the even number when the gray code is the even number. As a result, in the case that the uncertain bit is an LSB in the detected gray code in the land address field in the groove track, since N is the odd number, the number of “1”s of the gray code should be the odd number, and it is possible to determine whether the uncertain bit is “1” or “0”. If N is the even number, the gray code to be detected in the land address field is generated at a bit position other than the LSB. Consequently, in the case that the uncertain bit is a bit position other than the LSB in the gray code detected in the land address field in the groove track, since N is the even number, the number of “1”s of the detected gray code should be the even number, and it is possible to determine whether the uncertain bit is “1” or “0”.

With respect to the gray code “0101x” that is detected in the land address filed of the track G(27), since the LSB is uncertain, the number of “1”s in “0101 x” is the odd number, and “x” is determined to be “0”.

In the track G(26), since the uncertain bit is the bit position other than LSB from “0101x1”, the track address is the even number, and since the number of “1”s in “0101x1” is the even number, “x” is determined to be “1”.

(6) In the gray code data to be detected in the groove address field of the land track address N, the number of “1”s in the code is the odd number when the gray code is the odd number, and it becomes the even number when the gray code is the even number. This gray code data detected in the groove address field is synthesized as sandwiched between the groove track address N+1 and the groove track address N, and if N is the odd number, the bit position other than the LSB of the gray code sandwiched between the groove track addressed N and N+1 becomes the uncertain bit. As a result, in the case that the uncertain bit is the bit position other than the LSB in the gray code detected in the groove address field in the land track, since N is the odd number, the number of “1”s of the gray code should be the odd number, and it is possible to determine whether the uncertain bit is “1” or “0”. If N is the odd number, the gray code to be detected in the groove address field is generated at a bit position of the LSB. Consequently, in the case that the uncertain bit is the LSB in the gray code detected in the land address field in the land track, since N is the even number, the number of “1”s of the detected gray code should be the even number, and it is possible to determine whether the uncertain bit is “1” or “0”.

With respect to the gray code “010111x” that is detected in the groove address filed of the track L(26), since the LSB is uncertain, the number of “1”s in “0101x” is the even number, and “x” is determined to be “1”.

In the track L(25), since the uncertain bit is the bit position other than LSB from “0101x1”, the track address is the odd number, and the number of “1”s in “0101x1” is the odd number, so that “x” is determined to be “0”.

According to the above-described (5) and (6), if the detected gray code is converted into the binary code, it is possible to easily predict the uncertain position of the wobble signal (the track width variation position). In this case, not only the track width variation position can be predicted, but also the address data can be detected from the track width variation position and the detection result of the gray track (or the land track) address when reproducing the land track (or the groove track), and it may be considered that the address data is written doubly.

FIG. 19 is a configuration diagram of a circuit for detecting a tracking error (TE) signal, a wobble (WB) signal, and an RF signal from output signals of a four-divided detector 12 of an optical head for reading a signal from a general optical disk recording medium. The outputs of elements A and B of the four-divided detector 12 are supplied to an adder 14, and the outputs of elements C and D are supplied to an adder 16. The output of the adder 14 is supplied to a non-inversed input terminal (+) of differential amplifiers 18 and 20, and the output of the adder 16 is supplied to an inversed input terminal (−) of the differential amplifiers 18 and 20. Then, the output of the differential amplifier 18 is output via a low pass filter 22 as a tracking error (TE) signal, and it is output via a high pass filter 24 as a wobble (WB) signal. The output of the differential amplifier 20 is output as an RF signal.

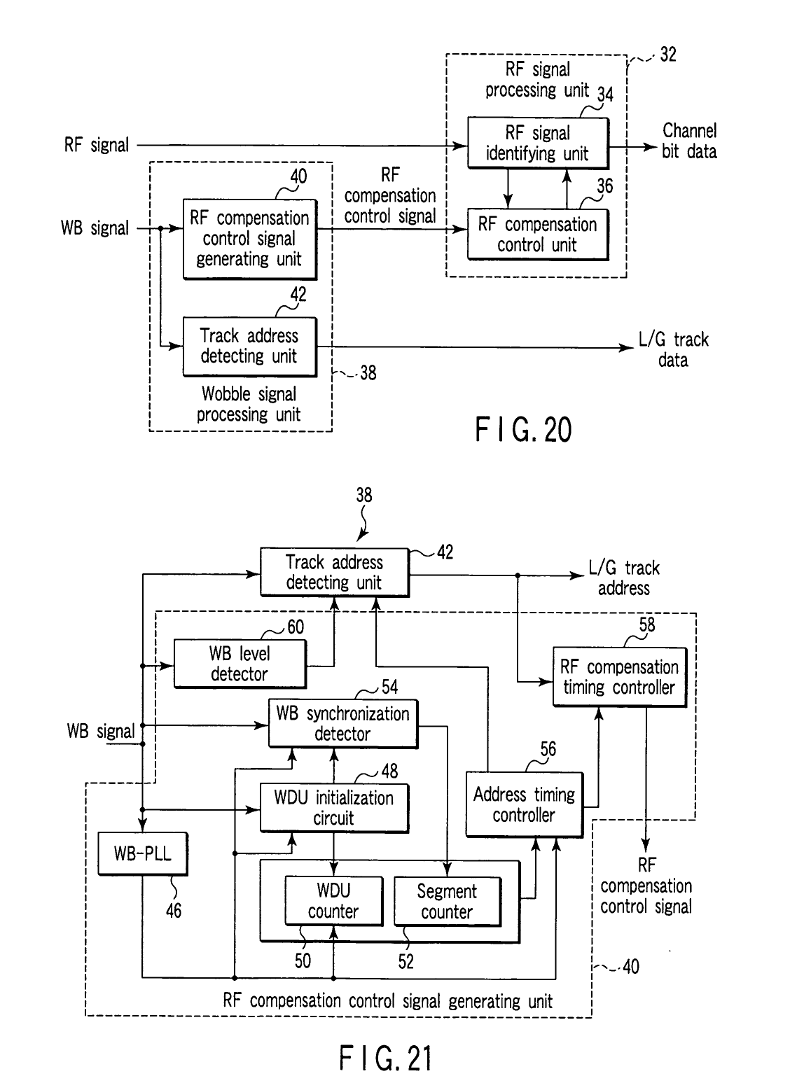

FIG. 20 is a block diagram of a reproduction signal processing unit. The reproduction signal processing unit is configured by a wobble signal processing unit 38 and an RF signal processing unit 32. The wobble signal processing unit 38 comprises a track address detecting unit 42 for detecting a track address from the wobble (WB) signal and an RF compensation control signal generating unit 40 for predicting a position of wobbling of the RF signal and its polarity. The RF signal processing 32 comprises an RF signal identifying unit 34 for identifying channel bit data from the RF signal and an RF compensation control unit 36 for receiving an RF compensation control signal to compensate the RF signal.

FIG. 21 shows the details of the wobble (WB) signal processing unit 38. The wobble (WB) signal processing unit 38 detects the address data and a position of wobbling of the RF signal from the wobble (WB) signal. The address data recorded by the wobble (WB) signal may be also detected by error due to damage and other defects, so that the address data detection including prevention of the error operation due to the error detection is needed.

The wobble (WB) signal is transmitted to a phase synchronization circuit (WB PLL) 46 and a reading clock in synchronization with the wobble (WB) signal is generated. By this clock, a WDU initialization circuit 48 detects a WDU divisional point to synchronize a WDU counter 50. Further, in the case that a synchronization signal of a segment is detected by a wobble synchronization detector 54, the WDU divisional point is correctly detected by the WDU initialization circuit 48, and when the wobble synchronization signal is detected, a segment counter 52 is synchronized.

The WDU counter 50 and the segment counter 52 have a function as a fly wheel counter, and when the synchronization signal is not generated, they automatically generate the WDU divisional point and the segment divisional point to control a reading timing of the address data. In other words, transmitting this counter information to an address timing controller 56, a timing control signal for reading the data is generated. This signal is transmitted to the track address detecting unit 42 and the address data is detected, but in this case, it is possible to use a signal level detection result from a wobble level detector 60 for checking the detection of the address data or the like. By using a signal that is detected in this way, an RF compensation timing controller 58 generates an RF compensation control signal indicating a position of wobbling of the RF signal generated at the track width variation position, its polarity and the like.

The RF compensation control signal generated in this way is transmitted to the RF signal processing 32 (FIG. 2), and then, the processing for compensating wobbling of the RF signal is carried out.

As described above, an uncertain position of the wobble (WB) signal of the gray code is obtained based on the binary code data as follows.

(1) For a Land Track:

The bit position of the first “0” viewed from the LSB side in the binary code is the uncertain position of the wobble (WB) signal of the gray code in the groove track address field.

(2) For a Groove Track:

The bit position of the first “1” viewed from the LSB side in the binary code is the uncertain position of the wobble (WB) signal of the gray code in the land track address field.

Since such a relation is established, if the detected gray code data is converted into the binary code, it is possible to easily predict the wobble (WB) signal uncertain position. In this case, not only the track width variation position can be predicted, but also the address data can be detected depending on at which bit the uncertain position of the groove address (or the land address) is detected upon detecting the address of the land track (or the groove track), and in this case, it may be considered that the address data is written doubly.

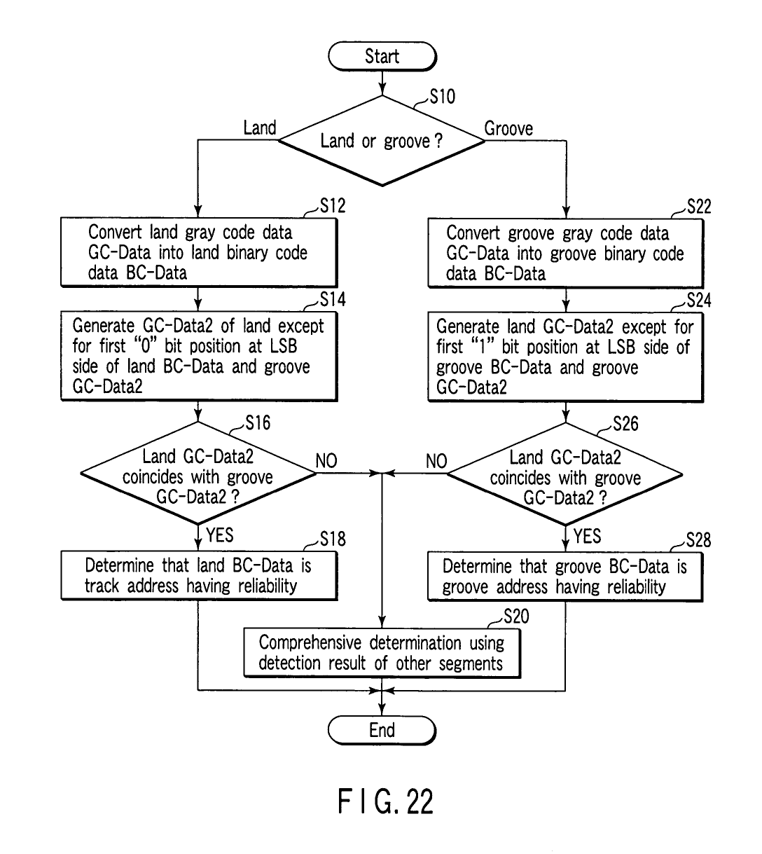

FIG. 22 shows a flow chart of an example of detecting the address data of the gray code from the wobble signal, determining the uncertain bit position by converting the detected address data into the binary data, detecting consistency in bit content between the gray code of the groove address field and that of the land address field, and checking a reliability. In FIG. 22, the consistency of remaining bits other than the uncertain bit is detected.

In step S10, it is determined whether a track that is currently recorded and reproduced is a land track or a groove track. If it is determined to be the land track, in step S12, the gray code data GC-Data of the land address field is converted into the binary code data BC-Data of the land address. In step S14, the gray code data GC-Data2 of the land address field except for the bit position of the first code bit “0” viewed from the LSB side of the binary code data BC-Data and the gray code data GC-Data2 of the groove address field are generated. In step S16, all the bits of the land address GC-Data2 are compared with all the bits of the groove address GC-Data2. If they coincide with each other, in step S18, assuming that the binary code data BC-Data of the land address is a reliable track address, the processing is completed.

If the track is determined to be a groove track in step S10, in step S22, the gray code data GC-Data of the groove address field is converted into the binary code data BC-Data of the groove address. In step S24, the gray code data GC-Data2 of the land address field except for the bit position of the first code bit “1” viewed from the LSB side of the binary code data BC-Data and the gray code data GC-Data2 of the groove address field are generated. In step S26, all the bits of the land address GC-Data2 may be compared with all the bits of the groove address GC-Data2. If they coincide with each other, in step S28, assuming that the binary code data BC-Data of the groove address is a reliable track address, the processing is completed.

As described above, in the address data of the gray codes read from the groove address field and the land address field during recording and reproducing of the track, the address data of itself is correctly recorded, and in the address data of a counter part, only one bit is uncertain and other bits are the same as the address data of itself. In this case, the bits except for the uncertain bit position should have the same bit contents, and the determinations in steps S16 and S26 should coincide with each other. However, each data may cause a bit error due to a defect or the like, and in the detection of the consistency of the bits in steps S16 and S26, an inconsistency determination result may be generated. Therefore, in such a case, in step S20, by using the determination results of other segments, comprehensive determination is carried out. Specifically, in the case of such inconsistency result, with reference to the detected address data in the previous and subsequent segments, the provisional determination whether the track is the designated track or not is carried out only from the consistency bits. In the provisional determination, it is important that if it is determined that “a possibility of the designated track is high”, the determination at this point is stopped and the determination having a reliability may be carried out in the next segment. In the halfway detection, only when the track is determined to be “not the designated track obviously”, shifting (seek other track) is performed, and in other cases, without shifting, the determination is left to the next detection. Specifically, since the track address data are located at plural positions, the detected track address is stored in a resister and a memory temporarily, and the next track address data is detected, whereby a reliability of the address data is checked.

In the recording operation, if a wrong place is overwritten, the original information is lost, so that such a behavior should be evaded. For that purpose, the detection of the address information is important. For example, when the address information is detected while seeking a prediction track and the address information is the same as the prediction track address information, it is determined that “a possibility of the designated track is high” yet. Since the track address information is recorded at plural locations, the next track address information is detected, and the predicted data to be located at a specific distance is detected with the same value, whereby the track is determined to be “a reliable designated track”. Then, determining the track as a recorded place with detection of other segment address or the like, the recording operation is started. The above-described “halfway” means a detection state that “this track is much likely to be the designated track”, and by detecting the state that “a possibility of the designated track is high” including a correlation of a distance in plural times, this state is changed to the state of “with a reliability” and this track is determined to be the designated track. If the track is determined to be “not the designated track obviously”, the place is not the designate track, but it is known that a certain track address is detected. From this address information, the number of tracks till the designated track is calculated, and the seek processing is shifted to a target track again.

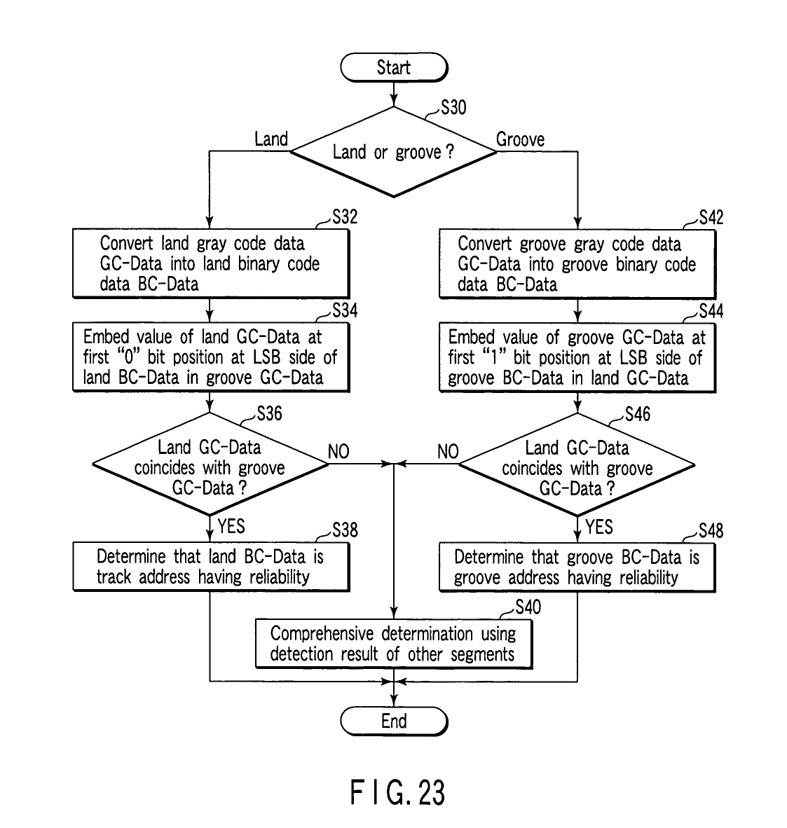

FIG. 23 is a flow chart showing another example of converting a gray code into binary data to determine an uncertain bit position, detecting the consistency between contents of gray code bits of a groove and a land, and performing checking of reliability. In FIG. 22, the consistency is determined by the bits except for the uncertain bit, but in FIG. 23, the value of the same bit position of a code of the counter part is embedded in the uncertain bit, and the consistency of all the bits is detected.

In step S30, it is determined whether a track that is currently recorded and reproduced is a land track or a groove track. If it is determined to be the land track, in step S32, the gray code data GC-Data of the land address field is converted into the binary code data BC-Data of the land address. In step S34, the value of the gray code data GC-Data of the land address field at the bit position of the first code bit “0” viewed from the LSB side of the binary code data BC-Data is embedded in the gray code data GC-Data of the groove address field. In step S36, all the bits of the land address GC-Data are compared with all the bits of the groove address GC-Data. If they coincide with each other, in step S38, assuming that the binary code data BC-Data of the land address is a reliable track address having, the processing is completed.

If the track is determined to be a groove track in step S30, in step S42, the gray code data GC-Data of the groove address field is converted into the binary code data BC-Data of the groove address. In step S44, the value of the gray code data GC-Data of the groove address field at the bit position of the first code bit “1” viewed from the LSB side of the binary code data BC-Data is embedded in the gray code data GC-Data of the land address field. In step S46, all the bits of the land address GC-Data are compared with all the bits of the groove address GC-Data. If they coincide with each other, in step S48, assuming that the binary code data BC-Data of the groove address is a reliable track address having, the processing is completed.

As described above, in the address data of the gray codes read from the groove address field and the land address field during recording and reproducing of the track, the address data of itself is correctly recorded, and the value of the position of the uncertain bit is embedded in the position corresponding to the counter part, so that the address data of the counter part should be the same as the address data of itself, and the determinations in steps S36 and S46 should be a coincidence. However, each data may cause a bit error due to a defect or the like, and in the detection of the consistency of the bits in steps S36 and S46, an inconsistency determination result may be generated. Therefore, in such a case, in step S40, by using the determination results of other segments, comprehensive determination is carried out. Specifically, in the case of such inconsistency result, with reference to the detected address data in the previous and subsequent segments, the provisional determination whether the track is the designated track or not is carried out only from the consistency bits. In the provisional determination, it is important that if it is determined that “a possibility of the designated track is high”, the determination at this point is stopped and a reliable determination may be carried out in the next segment. In the halfway detection, only when the track is determined to be “not the designated track obviously”, shifting is performed, and in other cases, the determination is left to the next detection.

As described above, according to the present embodiment, upon recording the address data represented by the gray code in the recording medium of the land and groove recording system by the wobble modulation, by converting the gray code into the binary code, the uncertain position of the wobble signal is detected, and the correlation between the address data of the land field and the address data of the groove field at the other bit positions, whereby the track address is reliably detected.

By using this relation inversely (detecting the uncertain area by using the fact that the level of the wobble signal is lowered in the uncertain area), even upon recording and reproducing the land track, it is possible to detect the land track address data by the gray code of the groove address field, and at the same time, even upon recording and reproducing the groove track, it is possible to detect the land track address data by the gray code of the land address field. This is equivalent to doubly writing of the address data.

As same as the above-described example, the processing will be described below taking a track 25 as an example.

(1) Upon Recording and Reproducing a Land Track:

If the uncertain position (a lower level position) is the LSB at the gray code of the groove address field, the data of the uncertain bit position is estimated (generated) so that the number of “1”s of each bit becomes the even number. If the uncertain position is other than the LSB, the data of the uncertain bit position is estimated (generated) so that the number of “1”s of each bit becomes the odd number. Other bit positions are defined to be the values of the detected data.

(2) Upon Recording and Reproducing a Groove Track:

If the uncertain position (a lower level position) is the LSB at the gray code of the land address field, the data of the uncertain bit position is estimated (generated) so that the number of “1”s of each bit becomes the odd number. If the uncertain position is other than the LSB, the data of the uncertain bit position is estimated (generated) so that the number of “1”s of each bit becomes the even number. Other bit positions are defined to be the values of the detected data.

By using this nature, the address data becomes as doubly written, so that the reliability can be improved.

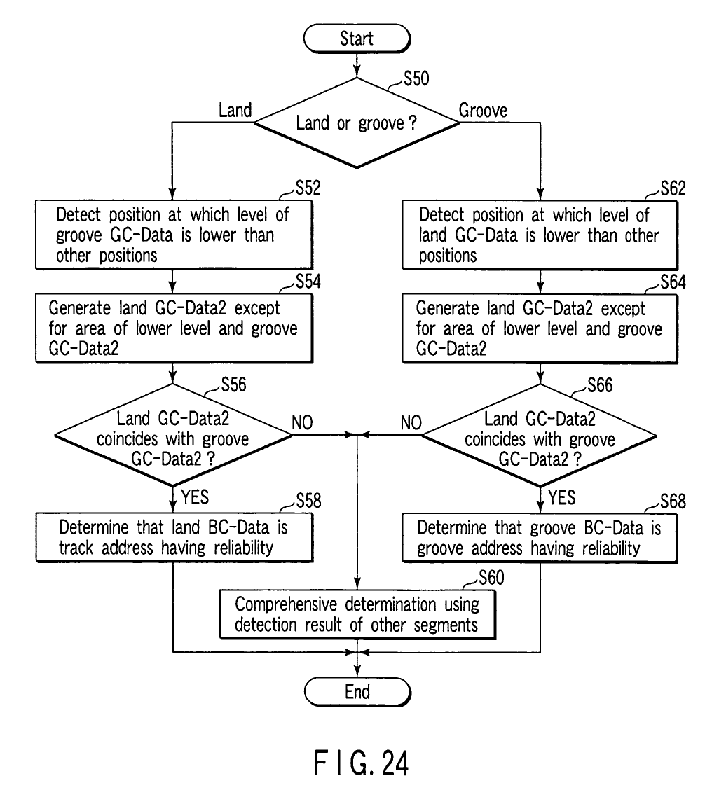

FIG. 24 is a flow chart when detecting an uncertain bit position from a state of an RF signal such as level down or the like, processing the uncertain position on the gray code till the reliability is detected, and finally, outputting it to the control system on the binary code as the address data. FIG. 24 corresponds to FIG. 22, and without using the information of the bit at the uncertain position that is leveled down, but by detection of the consistency of only the other bits, the reliability checking is carried out.

In step S50, it is determined whether a track that is currently recorded and reproduced is a land track or a groove track. If it is determined to be the land track, in step S52, a bit position at which a level of each bit of the gray code data GC-Data of the groove address field is lower than the other bits is detected. In step S54, the gray code data GC-Data2 of the land address field except for the bit position of the lower level and the gray code data GC-Data2 of the groove address field are generated. In step S56, all the bits of the land address GC-Data2 are compared with all the bits of the groove address GC-Data2. If they coincide with each other, in step S58, assuming that the binary code data BC-Data of the land address is a reliable track address having, the processing is completed.

If the track is determined to be a groove track in step S50, in step S62, a bit position at which a level of each bit of the gray code data GC-Data of the land address field is lower than the other bits is detected. In step S64, the gray code data GC-Data2 of the land address field except for the bit position of the lower level and the gray code data GC-Data2 of the groove address field are generated. In step S66, all the bits of the land address GC-Data2 are compared with all the bits of the groove address GC-Data2. If they coincide with each other, in step S68, assuming that the binary code data BC-Data of the groove address is a reliable track address having, the processing is completed.

As described above, excepting the value of the position of the uncertain bit, the address data of the land field should be the same as the address data of the groove field, and the determinations of steps S56 and S66 should be a coincidence. However, each data may cause a bit error due to a defect or the like, and in the detection of the consistency of the bits in steps S56 and S66, an inconsistency determination result may be generated. Therefore, in such a case, in step S60, by using the determination results of other segments, comprehensive determination is carried out. Specifically, in the case of such inconsistency result, with reference to the detected address data in the previous and subsequent segments, the provisional determination whether the track is the designated track or not is carried out only from the consistency bits. In the provisional determination, it is important that if it is determined that “a possibility of the designated track is high”, the determination at this point is stopped and a reliable determination may be carried out in the next segment. In the halfway detection, only when the track is determined to be “not the designated track obviously”, shifting is performed, and in other cases, the determination is left to the next detection.

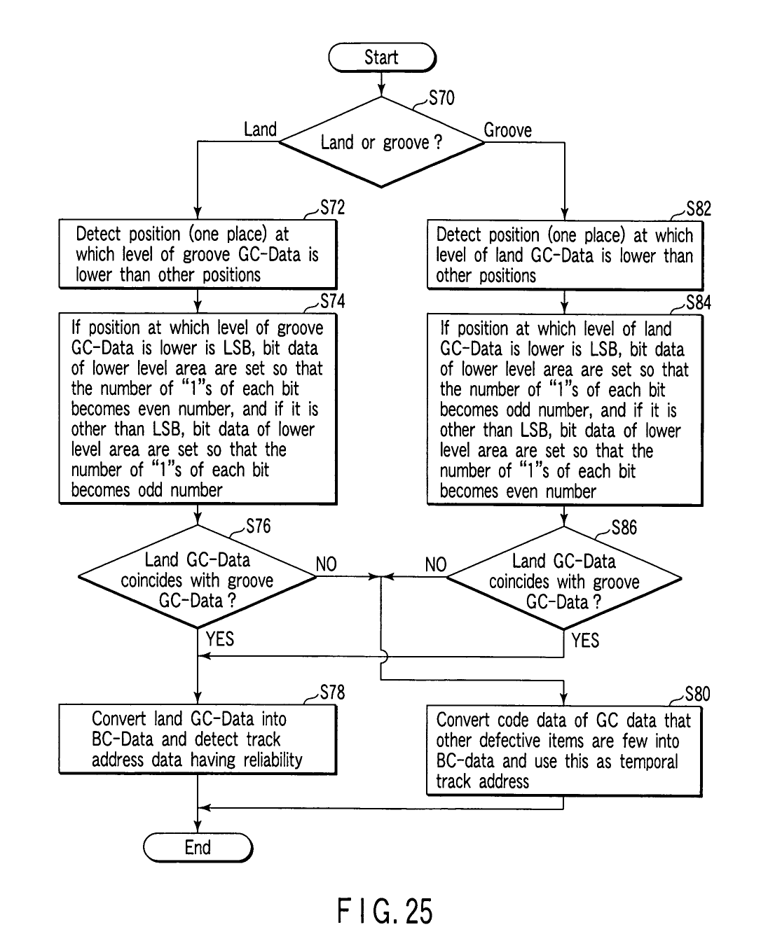

FIG. 25 is a flow chart when detecting an uncertain bit position from a state of an RF signal such as level down or the like, processing the uncertain position on the gray code till the reliability is detected, and finally, outputting it to the control system on the binary code as the address data. FIG. 25 corresponds to FIG. 23, and the consistency of all the bits can be detected by determining the data of the uncertain bit position as “1” or “0” depending on the number of “1”s or “0”s is the odd number of the even number and also depending on whether the position that is leveled down is the LSB or not.

In step S70, it is determined whether a track that is currently recorded and reproduced is a land track or a groove track. If it is determined to be the land track, in step S72, a bit position (one place) at which a level of each bit of the gray code data GC-Data of the groove address field is lower than the other bits is detected. In step S74, if the bit position at which a level of the gray code GC-Data of the groove address field is lower is the LSB, the data of the bit position of the lower level is set so that the number of “1”s of each bit becomes the even number, and if it is other than the LSB, the data of the bit position of the lower level is set so that the number of “1”s of each bit becomes the odd number. In step S76, all the bits of the land address GC-Data are compared with all the bits of the groove address GC-Data. If they coincide with each other, in step S78, converting the gray code data GC-Data of the land address field into the binary code data BC-Data, this binary code data BC-Data is output as a reliable track address having.

In step S70, when it is determined that the track that is currently recorded and reproduced is the groove track, in step S82, a bit position (one place) at which a level of each bit of the gray code data GC-Data of the land address field is lower than the other bits is detected. In step S84, if the bit position at which level of the gray code GC-Data of the land address field is lower is the LSB, the data of the bit position of the lower level is set so that the number of “1”s of each bit becomes the odd number, and if it is other than the LSB, the data of the bit position of the lower level is set so that the number of “1”s of each bit becomes the even number. In step S86, all the bits of the land address GC-Data are compared with all the bits of the groove address GC-Data. If they coincide with each other, in step S78, converting the gray code data GC-Data of the land address field into the binary code data BC-Data, this binary code data BC-Data is output as a reliable track address.

As described above, according to the processing in the flow chart shown in FIG. 25, together with the address data of itself, by using the address data of the counter part of which uncertain bit is determined based on the uncertain bit position, the address data can be detected. As a result, it is equivalent to read the double address data independently, and a final determination of the address data is carried out based on the data contents of the double address data. If the contents of the double address data do not coincide with each other, its cause is determined by other information if each data is damaged by a defect or the like. Upon shifting in the designated track, with reference to the address data of the previous segment, if any one the read address data of itself and the counter part is the same as that of the address data of the previous segment, even when both the address data do not coincide with the address data in the previous segment, it is determined that a possibility of the designated track is high. Therefore, in step S80, converting the code data of the gray code that other defective items are few into a binary code, this binary code is used as a temporal track address.

As described above, according to the embodiments of the present invention, by detecting the gray code of the land address and the gray code of the groove address and then, detecting the bit position of the first “0” or “1” of the binary code viewed from the LSB as a data uncertain position, the address data is detected based on this detection result and the gray code and this makes it possible to improve a reliability of the address data.

By detecting the gray code of the land address and the gray code of the groove address, detecting a data uncertain position with a lower level from among the gray codes of the groove address upon recording and reproducing the land track, and detecting a data uncertain position with a lower level from among the gray codes of the land address upon recording and reproducing the groove track, the address data is detected based on this detection result and the gray code and this makes it possible to improve a reliability of the address data.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

1. An address data detecting apparatus for detecting address data from a recording medium of a land and groove recording system in which a gray code of a land address and a gray code of a groove address are wobble-modulated and recorded, the apparatus comprising:
a gray code detector which detects the gray code of the land address and the gray code of the groove address;
a converter which converts the gray code of the land address and the gray code of the groove address that are detected by the gray code detector into binary codes;
a position detector which detects a bit position of the first “0” or “1” of the binary code viewed from a least significant bit as a data uncertain position; and
an address detector which detects the address data based on a detection result of the position detector and the gray code of the land address and the gray code of the groove address that are detected by the gray code detector.

2. The address data detecting apparatus according to claim 1, wherein the address detector detects the address data based on the gray code of the land address and the gray code of the groove address except for the data of the data uncertain position.

3. The address data detecting apparatus according to claim 2, wherein the address detector outputs an address of the binary code when the gray code of the land address and the gray code of the groove address coincide with each other.

4. The address data detecting apparatus according to claim 1, wherein the address detector embeds data of a gray code of a groove address at a corresponding position as the data of the gray code of the bit position of the first “0” of the binary code viewed from the least significant bit during recording and reproducing of the land track, embeds data of a gray code of a land address at a corresponding position as the data of the gray code of the bit position of the first “1” of the binary code viewed from the least significant bit during recording and reproducing of the groove track, and detects the address data based on the gray code of the land address and the gray code of the groove address.

5. The address data detecting apparatus according to claim 4, wherein the address detector outputs an address of the binary code when the gray code of the land address and the gray code of the groove address coincide with each other.

6. An address data detecting apparatus for detecting address data from a recording medium of a land and groove recording system in which a gray code of a land address and a gray code of a groove address are wobble-modulated and recorded, the apparatus comprising:
a gray code detector which detects the gray code of the land address and the gray code of the groove address;
a position detector which detects a data uncertain position with a lower level from among the gray codes of the groove address during recording and reproducing of the land track, and detects a data uncertain position with a lower level from among the gray codes of the land address during recording and reproducing of the groove track; and
an address detector which detects the address data based on a detection result of the position detector and the gray code of the land address and the gray code of the groove address.

7. The address data detecting apparatus according to claim 6, wherein the address detector detects the address data based on the gray code of the land address and the gray code of the groove address except for the data of the data uncertain position.

8. The address data detecting apparatus according to claim 7, wherein the address detector outputs an address of the binary code converted from the gray code of the land address and the gray code of the groove address when the gray code of the land address and the gray code of the groove address coincide with each other.

9. The address data detecting apparatus according to claim 6, wherein the address detector sets bit data at the data uncertain position so that the number of “1” bits becomes an even number if the data uncertain position of the groove address is the least significant bit and the number of “1” bits becomes an odd number if the data uncertain position of the groove address is other than the least significant bit during recording and reproducing of the land track and the number of “1” bits becomes an odd number if the data uncertain position of the land address is the least significant bit and the number of “1” bits becomes an even number if the data uncertain position of the land address is other than the least significant bit during recording and reproducing of the groove track, and detects the address data based on the gray code of the land address and the gray code of the groove address.

10. The address data detecting apparatus according to claim 9, wherein the address detector outputs an address of the binary code converted from the gray code of the land address and the gray code of the groove address when the gray code of the land address and the gray code of the groove address coincide with each other.

11. An address data detecting method for detecting address data from a recording medium of a land and groove recording system in which a gray code of a land address and a gray code of a groove address are wobble-modulated and recorded, the method comprising:
a gray code detecting step for detecting the gray code of the land address and the gray code of the groove address;
a converting step for converting the gray code of the land address and the gray code of the groove address that are detected by the gray code detecting step into binary codes;
a position detecting step for detecting a bit position of the first “0” or “1” of the binary code viewed from a least significant bit as a data uncertain position; and
an address detecting step for detecting the address data based on a detection result of the position detecting step and the gray code of the land address and the gray code of the groove address that are detected by the gray code detecting step.

12. The address data detecting method according to claim 11, wherein the address detecting step detects the address data based on the gray code of the land address and the gray code of the groove address except for the data of the data uncertain position.

13. The address data detecting method according to claim 12, wherein the address detecting step outputs an address of the binary code when the gray code of the land address and the gray code of the groove address coincide with each other.

14. The address data detecting method according to claim 11, wherein the address detecting step embeds data of a gray code of a groove address at a corresponding position as the data of the gray code of the bit position of the first “0” of the binary code viewed from the least significant bit during recording and reproducing of the land track, embeds data of a gray code of a land address at a corresponding position as the data of the gray code of the bit position of the first “1” of the binary code viewed from the least significant bit during recording and reproducing of the groove track, and detects the address data based on the gray code of the land address and the gray code of the groove address.

15. The address data detecting method according to claim 14, wherein the address detecting step outputs an address of the binary code when the gray code of the land address and the gray code of the groove address coincide with each other.

16. An address data detecting method for detecting address data from a recording medium of a land and groove recording system in which a gray code of a land address and a gray code of a groove address are wobble-modulated and recorded, the method comprising:
a gray code detecting step for detecting the gray code of the land address and the gray code of the groove address;
a position detecting step for detecting a data uncertain position with a lower level from among the gray codes of the groove address during recording and reproducing of the land track, and detecting a data uncertain position with a lower level from among the gray codes of the land address during recording and reproducing of the groove track; and
an address detecting step for detecting the address data based on a detection result of the position detecting step and the gray code of the land address and the gray code of the groove address.

17. The address data detecting method according to claim 16, wherein the address detecting step detects the address data based on the gray code of the land address and the gray code of the groove address except for the data of the data uncertain position.

18. The address data detecting method according to claim 17, wherein the address detecting step outputs an address of the binary code converted from the gray code of the land address and the gray code of the groove address when the gray code of the land address and the gray code of the groove address coincide with each other.

19. The address data detecting method according to claim 16, wherein the address detecting step sets bit data at the data uncertain position so that the number of “1” bits becomes an even number if the data uncertain position of the groove address is the least significant bit and the number of “1” bits becomes an odd number if the data uncertain position of the groove address is other than the least significant bit during recording and reproducing of the land track and the number of “1” bits becomes an odd number if the data uncertain position of the land address is the least significant bit and the number of “1” bits becomes an even number if the data uncertain position of the land address is other than the least significant bit during recording and reproducing of the groove track, and detects the address data based on the gray code of the land address and the gray code of the groove address.

20. The address data detecting method according to claim 19, wherein the address detecting step outputs an address of the binary code converted from the gray code of the land address and the gray code of the groove address when the gray code of the land address and the gray code of the groove address coincide with each other.
